(19) United States
(12) Patent Application Publication
(10) Pub. No.: US 2016/0319807 A1
(43) Pub. Date: Nov. 3, 2016

(54) SELF-BLEEDING, SELF-PRIMING, REVERSIBLE CIRCUIT

(71) Applicant: Parker-Hannifin Corporation, Cleveland, OH (US)

(72) Inventors: Bryan J. Anderson, Champlin, MN (US); Tom Fugle, Shakopee, MN (US)

(21) Appl. No.: 15/002,739

(22) Filed: Jan. 21, 2016

Related U.S. Application Data
(60) Provisional application No. 62/154,404, filed on Apr. 29, 2015.

(51) Int. Cl. F04B 17/03; F16K 15/18; F16K 3/26

(52) U.S. Cl. CPC F04B 17/03; F16K 3/26; F16K 15/186

(57) ABSTRACT

A hydraulic power unit for controlling a work unit includes a reservoir for storing hydraulic fluid, a hydraulic pump for moving fluid from the reservoir, a prime mover for driving the hydraulic pump, and a manifold for controlling flow between the work unit, pump and reservoir. The manifold includes a spool valve assembly with a spool that is translatable within a spool bore to provide this control. The spool bore is fluidly connected to the work unit via a pair of work passages, to the hydraulic pump via a pair of supply passages, and to the reservoir via a return passage. The manifold is configured to direct fluid flow received from the work unit at either of the work passages to the reservoir while bypassing the pump by preventing fluid flow through the spool bore in a direction from either of the work passages to either of the supply passages.

### FIELD OF INVENTION

The present invention relates generally to reversible hydraulic power units, and more particularly to a reversible hydraulic power unit having a manifold for allowing self-bleeding and self-priming of the power unit.

### BACKGROUND

A typical hydraulic power unit includes a prime mover, such as an electric unit motor, which drives a hydraulic pump to move fluid from a reservoir of the power unit to a work unit, such as a hydraulic cylinder or reversible motor. In the case that the work unit is a hydraulic cylinder, when the prime mover is driven in a first rotational direction, hydraulic fluid moved by the hydraulic pump extends the rod of the cylinder. When the prime mover is driven in a second rotational direction, opposite to the first rotational direction, the hydraulic fluid moved by the hydraulic pump retracts the rod of the cylinder.

A manifold of the power unit is typically fluidly disposed between the hydraulic pump and the work unit to control flow between the hydraulic pump and the work unit. The manifold also typically includes one or more check valves to maintain pressure in the work unit until such time that the prime mover is activated to control the work unit, such as retracting versus extending a hydraulic cylinder work unit. A typical configuration of a manifold generally allows for hydraulic fluid to be pumped from the hydraulic pump through the manifold and into one port of a work unit, such as into one side of a hydraulic cylinder. Concurrently, hydraulic fluid is generally moved from the opposing side of the hydraulic cylinder from an opposing port of the work unit through the manifold and back to the hydraulic pump. The reverse is effected upon reversal of the prime mover.

### SUMMARY OF INVENTION

The present invention provides a hydraulic power unit for controlling a work unit. The power unit includes a reservoir for storing hydraulic fluid, a hydraulic pump for moving fluid from the reservoir, a prime mover for driving the hydraulic pump, and a manifold for controlling flow between the work unit and the pump and reservoir. The manifold includes a spool valve assembly with a spool that is translatable within a spool bore to provide this control. The spool bore is fluidly connected (a) to the work unit via a pair of work passages, (b) to the hydraulic pump via a pair of supply passages, and (c) to the reservoir via a return passage. The manifold is configured to direct fluid flow received from the work unit at either of the work passages to the reservoir while bypassing the pump by preventing fluid flow through the spool bore in a direction from either of the work passages to either of the supply passages.

According to one aspect of the invention, a manifold for controlling flow between work passages of the manifold to provide hydraulic work force to a work unit connectable to the manifold includes a manifold body defining a spool bore extending along a longitudinal spool axis between opposed longitudinal ends. The manifold also includes a pair of work passages for fluid communication with the work unit, a pair of supply passages for fluid communication with a supply of fluid, and a return passage for fluid communication with a fluid reservoir, where each of the work passages, supply passages and return passage extend between an external surface of the manifold body and the spool bore. Further included is a movable spool disposed in the spool bore that fluidly separates the work passages from one another and the supply passages from one another in the spool bore, the spool being longitudinally translatable along the spool axis between first and second positions at the opposed longitudinal ends and a default position spaced between the first and second positions to control flow of fluid between the work, supply and return passages. The work passages and the supply passages are each fluidly separated from the return passage in the spool bore when the spool is in the default position. The return passage and one work passage of the pair of work passages are fluidly connected to one another in the spool bore while the return passage is fluidly separated from the other work passage of the pair of work passages in the spool bore when the spool is in each of the first and second positions.

The spool may translate in response to pressure received from the supply passages.

The spool may have opposed longitudinal spool end surfaces fluidly separated from one another in the spool bore via a seal disposed at least partially in the spool bore between the longitudinal spool end surfaces.

The one work passage of the pair of work passages may be fluidly separated from the supply passages in the spool bore when the spool is in each of the first and second positions.

The other work passage of the pair of work passages and one supply passage of the pair of supply passages may be fluidly connected to one another in the spool bore, while the other supply passage of the pair of supply passages is fluidly separated from each of the work passages, the one supply passage and the return passage in the spool bore when the spool is in each of the first and second positions.

Each work passage of the pair of work passages may open to one of the opposed longitudinal ends of the spool bore.

The spool may further include a pair of transfer passages defined therein and fluidly separated from one another, where each transfer passage extends between one longitudinal spool end surface and a longitudinal spool surface extending between the longitudinal spool end surfaces, and where each transfer passage provides for fluid connection of the one or the other of the work passages with the return passage upon alignment of the respective transfer passage with the return passage when the spool is in each of the first and second positions.

Each of the transfer passages may be fluidly separated from the return passage in the spool bore when the spool is in the default position.

The spool may further include a skirt extending longitudinally from each of opposed longitudinal spool end surfaces of the spool, where the skirt fluidly separates the one work passage of the pair of work passages from the respective supply passage in the spool bore when the spool is in each of the first and second positions.

Each skirt may be a full annular projection.

The manifold may further include a pair of check valves disposed at the opposed longitudinal ends of the spool bore, where each check valve is fluidly positioned between one work passage of the pair of work passages and the remainder of the work, supply and return passages.

Each check valve may include a check seat for mating with the spool to fluidly separate the one work passage of the pair of work passages from the respective supply passage in the spool bore when the spool is in each of the first and second positions.

The spool may further include a tang extending longitudinally from each of the opposed longitudinal spool end surfaces to engage and open one of the check valves when the spool is in each of the first and second positions.

The manifold may be configured to prevent fluid flow through the spool bore in a direction from either of the work passages to either of the supply passages.

A hydraulic power unit for controlling flow between opposed work ports of a work unit may include a reservoir for hydraulic fluid, a hydraulic pump for moving fluid from the reservoir, a prime mover for causing the hydraulic pump to move the fluid, and the manifold, where the pair of work passages are connected to the work unit, the return passage is connected to the reservoir, and the pair of supply passages are connected to the hydraulic pump to receive fluid pumped from the hydraulic pump.

According to another aspect of the invention a hydraulic power unit for controlling flow between opposed work ports of a work unit includes a reservoir for hydraulic fluid, a hydraulic pump for moving fluid from the reservoir, a prime mover for causing the hydraulic pump to move the fluid, and a manifold fluidly connected to each of the reservoir and the hydraulic pump, the manifold including a spool valve assembly for controlling fluid flow between the work unit and each of the pump and the reservoir, where the spool valve assembly is configured to direct fluid flow received from either of the work ports to the reservoir while bypassing the hydraulic pump.

The spool valve assembly may include a spool translatable within a spool bore, the spool having opposed longitudinal ends each shaped to prevent fluid flow in a direction from the work unit to the hydraulic pump through the spool bore while directing fluid flow in a direction from the work unit to the reservoir through the spool bore.

According to another aspect of the invention, there is a method of controlling flow between work passages of a manifold including a spool valve assembly having a spool translatable within a spool bore, the spool bore fluidly connected to (a) first and second work passages for connecting to a work unit, (b) respective first and second supply passages for connecting to a hydraulic pump, and (c) a return passage for connecting to a fluid reservoir. The method including the steps of (i) in a default position of the spool, fluidly separating each of the work passages, supply passages and return passage from one another, (ii) in a first position of the spool spaced from the default position, allowing fluid flow from the first work passage to the return passage through the spool bore, allowing fluid flow from the second supply passage to the second work passage through the spool bore, and fluidly separating the first supply passage from the other of the work, supply and return passages through the spool bore, and (iii) in a second position of the spool spaced from each of the default and first positions, allowing fluid flow from the second work passage to the return passage, allowing fluid flow from the first supply passage to the first work passage, and fluidly separating the second supply passage from the other of the work, supply and return passages.

The method may further include the step of translating the spool between the first and second positions in response to pressure received from the supply passages.

The method may further include the step of directing fluid flow received into either work passage of the manifold from the work unit to the reservoir while bypassing the hydraulic pump.

The foregoing and other features of the invention are hereinafter described in greater detail with reference to the accompanying drawings.

### BRIEF DESCRIPTION OF THE DRAWINGS

FIG. 1 is an orthogonal view of an exemplary hydraulic power unit.

FIG. 2 is another orthogonal view of the hydraulic power unit of FIG. 1 with the reservoir removed.

FIG. 3 is yet another orthogonal view of the hydraulic power unit of FIG. 1 with the reservoir removed.

FIG. 4 is an elevated cross-section view of a manifold of a prior art hydraulic power unit.

FIG. 5 is an orthogonal view of a prior art spool of the manifold of FIG. 4.

FIG. 6 is a partial elevated cross-section view of the manifold of the exemplary hydraulic power unit of FIG. 1.

FIG. 7 is another partial elevated cross-section view of the manifold of the exemplary hydraulic power unit of FIG. 1.

FIG. 8 is an orthogonal view of a spool for use with a manifold of the exemplary hydraulic power unit of FIG. 1.

FIG. 9 is another orthogonal view of a spool for use with a manifold of the exemplary hydraulic power unit of FIG. 1.

FIG. 10 is an elevated cross-section view of the manifold of the exemplary hydraulic power unit of FIG. 1.

FIG. 11 is another elevated cross-section view of the manifold of the exemplary hydraulic power unit of FIG. 1.

FIG. 12 is yet another elevated cross-section view of the manifold of the exemplary hydraulic power unit of FIG. 1.

FIG. 13 is a schematic representation of the hydraulic power unit of FIG. 1.

### DETAILED DESCRIPTION

The principles of the present disclosure have particular application to reversible power units for controlling work units such as extendable cylinders or reversible motors. An exemplary application may be a reversible hydraulic power unit used in the extension and retraction of one or more hydraulic cylinders for moving one or more portions of an extendable recreational vehicle or trailer. Of course, the principles of the present disclosure may also be useful in other applications including in a fork lift or trailer lift or in any other application requiring a hydraulic cylinder or reversible motor. The principles of the present disclosure are also applicable to hydraulic power units using a hydraulic fluid that may include one or more of oil, water, glycol-ether, etc.

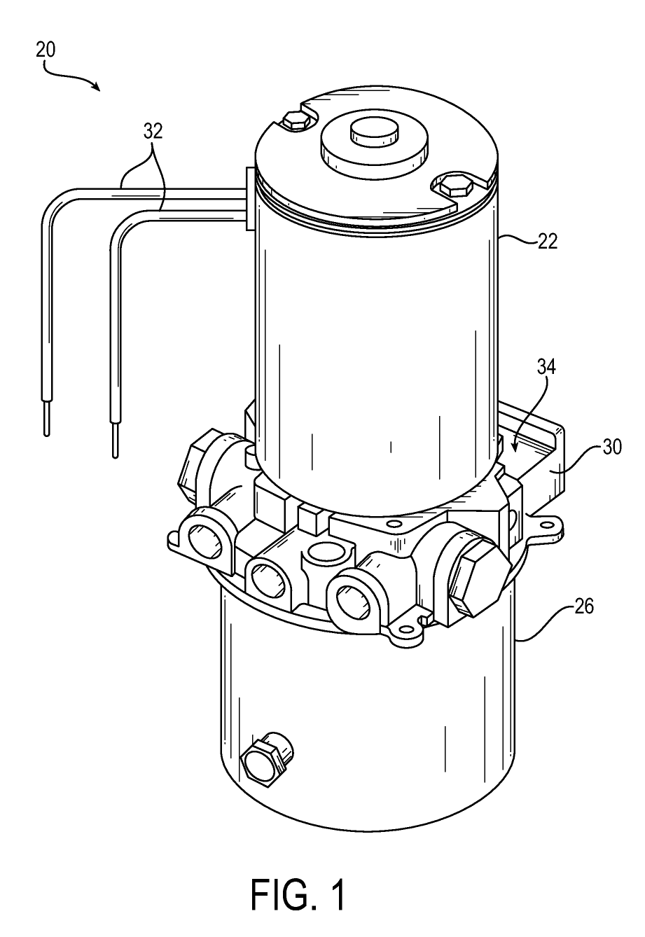

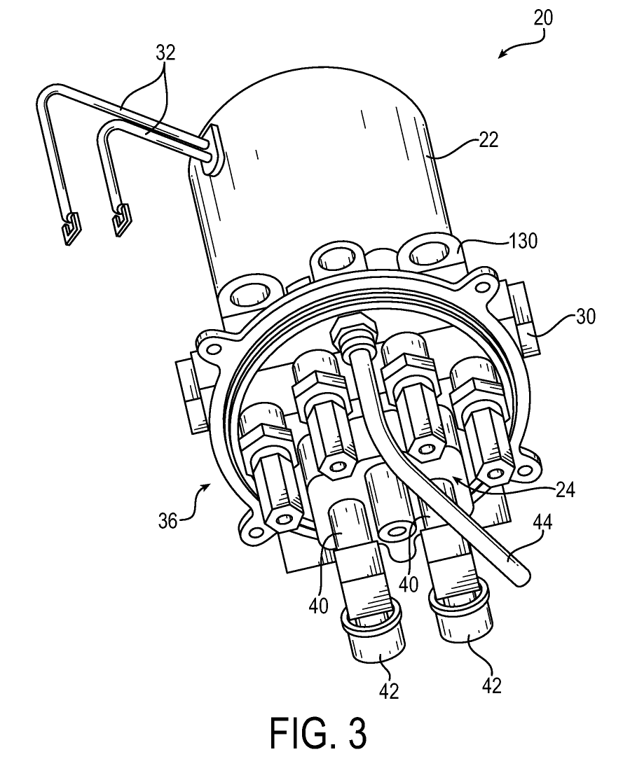

Turning now to FIGS. 1-3, an exemplary power unit, such as an exemplary hydraulic power unit 20, is depicted including a primer mover, such as an electric motor 22, and a pump, such as a hydraulic pump 24. The pump 24 is powered by the motor 22 to move fluid from a reservoir 26 through a manifold 30 to control a work unit (not shown). Although the manifold 30, reservoir 26, pump 24 and motor 22 are preferably each shown as separate components, one or more of these components could be unitary with any other of the components.

The motor 22 includes wires 32 for connecting to a suitable power source (not shown), such as a battery. A controller (not shown) may also be connected to the motor 22 to control when the motor will operate in a first direction versus in a second, such as opposite, direction to reversibly control the work unit. The motor 22 is shown as connected to a first side 34 of the manifold 30 and separated from the pump 24 via the manifold 30, though the components may be otherwise suitably assembled to one another in other embodiments.

The reservoir 26 and pump 24 are depicted as connected to a second side 36 of the manifold 30, opposite the first side 34. The reservoir 26, such as a hydraulic fluid tank, is shown as disposed about the pump 24, though the pump 24 may be disposed external to the reservoir 26 in other embodiments. When powered by the motor 22, the pump 24 draws hydraulic fluid from the reservoir 26 into the manifold 30 via supply ports 40. As shown, filters 42 are connected to the supply ports 40 and disposed in the flow path of fluid from the reservoir 26 into the manifold 30. The filters 42 are included for filtering out contaminant from the hydraulic fluid contained in the reservoir 26. The filters 42 may include any suitable filter media.

The manifold 30 is connected to each of the reservoir 26, pump 24 and respective work unit to generally control fluid flow between the work unit and each of the pump 24 and reservoir 26. This control is achieved in the manifold 30 by controlling flow between respective work ports of the manifold 30 to provide hydraulic power to the respective work unit. More particularly, the manifold 30 is configured to direct fluid flow received from the work unit, such as from either of typical opposing work ports of the work unit, through the manifold 30 and into the reservoir 26 via a return port, such as the depicted return tube 44.

Through the manifold 30, the fluid returning from the work unit is directed to bypass the hydraulic pump 24, thus causing fluid received from the work unit and exiting the manifold 30 to return to the reservoir 26. In the reservoir 26 the fluid is filtered by the filters 42 prior to being drawn into the pump 24. Thus fluid is not merely pumped from one side of a work unit, such as one side of a hydraulic cylinder, to the other side and vice versa.

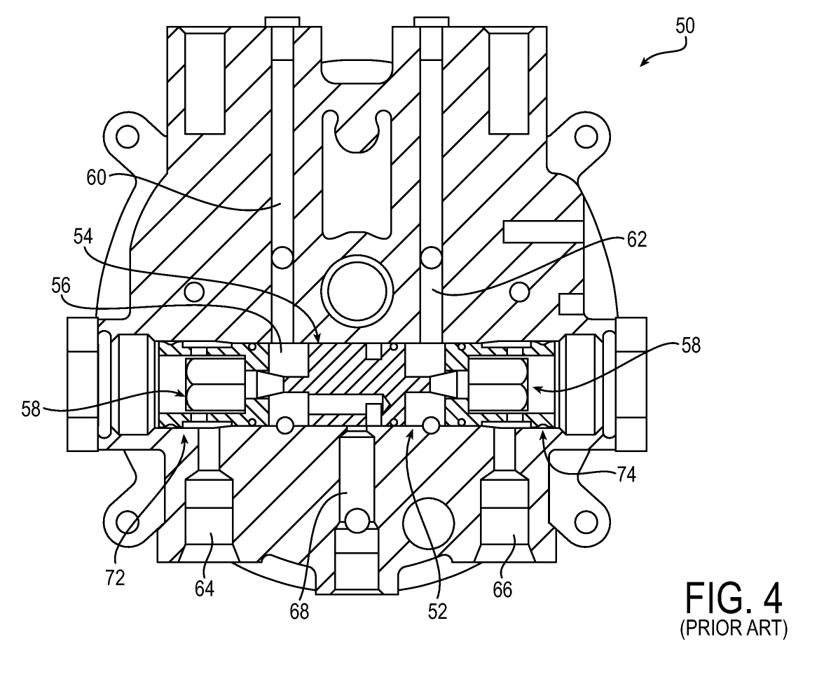

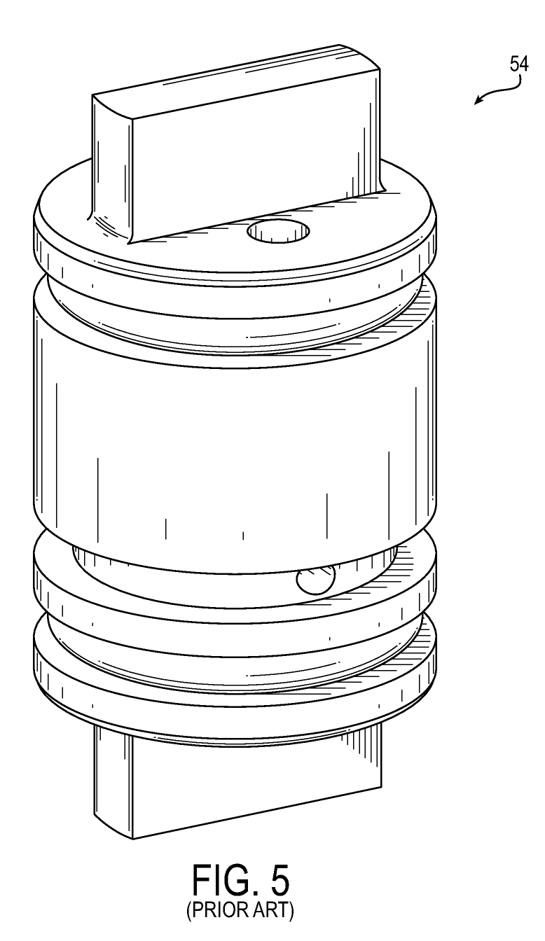

Conversely, in a conventional hydraulic power unit for use with a hydraulic cylinder, much of the fluid used to extend and retract the cylinder will merely traverse between the rod and piston sides of the cylinder, such as via a pump of the conventional hydraulic power unit. One exemplary manifold used in such a conventional hydraulic power unit is shown in FIGS. 4 and 5. The manifold 50 includes a spool valve assembly 52 that includes a spool 54 translatable in a spool bore 56. The spool 54 is shaped to open corresponding check valves 58 of the manifold 50 while controlling flow through the manifold 50. Flow is controlled between a work unit, such as a hydraulic cylinder, a hydraulic pump of the conventional power unit that feeds the work unit, and a reservoir of the conventional power unit from which the pump may draw fluid.

In the manifold 50, supply passages 60 and 62 are fluidly connected to the bore 56 for connecting to the pump of the conventional power unit. Work passages 64 and 66 are connected with the bore 56 for connecting to a work unit, such as a typical hydraulic cylinder. The first work passage 64 is connected to the piston side of the cylinder while the second work passage 66 is connected to the rod side of the cylinder. A return passage 68 also is connected to the bore 56 for connecting with the reservoir of the conventional power unit.

Via supply of fluid and pressure from the respective pump through the second supply passage 62, the spool 54 is translated to a first longitudinal side 72 of the bore 56. The rod side of the cylinder and the second work passage 66 are connected to the second supply passage 62 for feeding the rod side of the cylinder with increased fluid and pressure. The piston side of the cylinder and the first work passage 64 are connected to the first supply passage 60 and to the return passage 68 for at least partially emptying the piston side. Thus fluid is pumped from the piston side to the rod side of the hydraulic cylinder between the supply passages 62 and 60 via the conventional pump disposed therebetween. A small portion of the fluid emptied from the piston side represents the rod volume of fluid moving through the return passage 68 and is emptied to the respective reservoir through the spool 54.

On the other hand, via supply of fluid and pressure from the respective pump through the first supply passage 60, the spool 54 is translated to a second longitudinal side 74 of the bore 56. The piston side of the cylinder and the first work passage 64 are connected to the first supply passage 60 for now supplying the cylinder piston side with pressure and fluid. The rod side of the cylinder and the second work passage 66 are connected to the second supply passage 62 to allow subsequent emptying of the rod side. The return passage 68 is fluidly separated from the other of the work passages 64 and 66 and the supply passages 60 and 62 in the spool bore 56. Thus fluid is pumped from the rod side to the piston side of the hydraulic cylinder, and the pump draws only a small amount of fluid from the respective reservoir to send to the piston side where this small amount of fluid represents the rod volume of fluid.

Accordingly, the fluid in the work unit and conventional power unit will not regularly be returned to the reservoir to allow for escape of gas, such as air, and filtration of contaminant from the fluid. This gas and contaminant will instead remain in the work unit and manifold, being moved between the rod and piston sides and into the pump, causing the pump to lose prime. As a consequence, the power unit and work unit may suffer reduced efficiencies, reduced working lives, additional maintenance requirements, greater working noise and periodic malfunctions. Further, the hydraulic fluid may require frequent filtering or changing due to build up from contaminant and increased breakdown, for example due to lack of time to cool while being transferred between work ports of the work unit.

Referring back to FIGS. 1-3, the power unit 20 of the present invention avoids or reduces many of these fallbacks. Gas and contaminant in the respective system, such as gas in a hydraulic cylinder work unit at initial startup, are directed into the reservoir 26 and not directly back to the pump 24 or to the work unit. In this way, the manifold 30, and thus the hydraulic power unit 20, is configured to self-bleed or self-prime upon initial startup. The fluid is able to cool in the reservoir 26 prior to being pumped back into the pump 24. Gas also may be vented via a suitable vent in the reservoir 26. The self-priming provides for more efficient flow through the manifold 30 and the unit 20, and puts less mechanical stress on the pump 24 due to a low quantity of gas and contaminants reintroduced into the respective system.

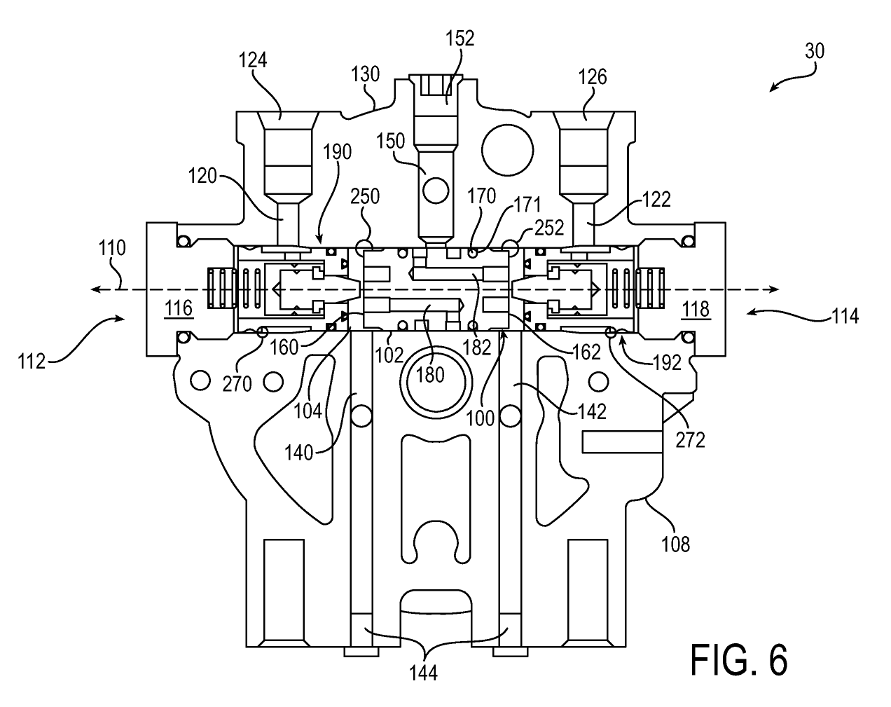

For example, turning now to FIG. 6, the exemplary manifold 30 is shown in partial cross-section and includes a spool valve assembly 100 that is generally configured to direct fluid flow received from either of opposing work ports of a respective work unit hydraulic cylinder to the respective reservoir 26 while bypassing the respective hydraulic pump 24. The spool valve assembly 100 is fluidly connectable to each of the work unit, the reservoir 26 and the pump 24. The spool valve assembly 100 has a spool 102 translatable in a spool bore 104 for controlling the fluid flow through the manifold 30 between the work unit and the reservoir 26 and the pump 24.

The manifold 30 has a manifold body 108 defining the spool bore 104 of the spool valve assembly 100. The spool bore 104 extends along a longitudinal spool axis 110 between opposed longitudinal ends 112 and 114. Plugs 116 and 118 close the longitudinal ends 112 and 114. The plugs 116 and 118 may be inserted into the spool bore 104 or may be integral with the manifold body 108. In some embodiments, separate plugs 116 and 118 may be attached to the manifold body 108 via welding, adhesives, etc.

Preferably, the spool bore 104 is cylindrically-shaped to enable translation therein of a corresponding spool 102 that is preferably cylindrically-shaped. The movable spool 102 longitudinally translates along the spool axis 110 to control fluid flow between a plurality of passages fluidly connected to the spool bore 104, including work, supply, and return passages.

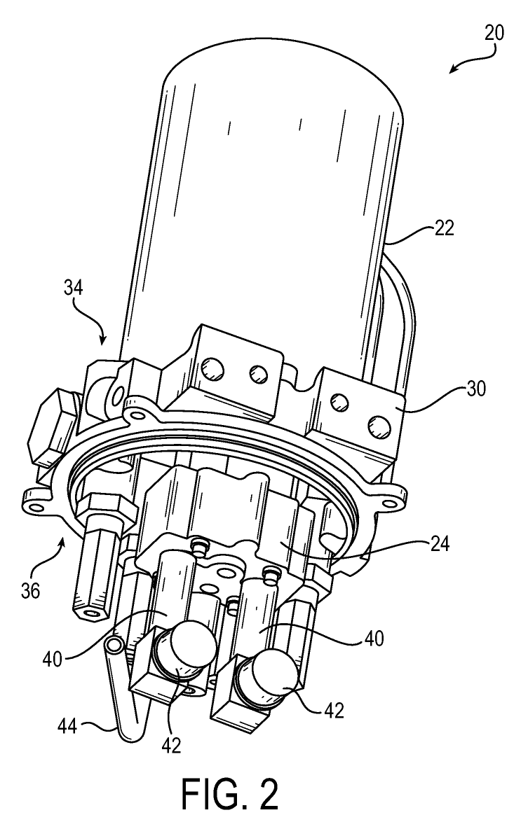

A pair of work passages 120 and 122 is defined in the manifold body 108 for fluid communication between the spool valve assembly 100 and the work unit. The work passages 120 and 122 extend between the spool bore 104 and respective work ports 124 and 126 at an external surface of the manifold 30, such as an intermediate surface 130 extending between the first and second surfaces 34 and 36 (FIG. 2). More particularly, the work passages 120 and 122 are fluidly connected to the longitudinal ends 112 and 114, respectively, and are separated from one another within the spool bore 104 by the spool 102. Suitable hoses may connect the opposing work ports 124 and 126 with respective opposing work ports of the work unit.

A pair of supply passages 140 and 142 is also defined in the manifold body 108 for fluid communication between the spool valve assembly 100 and the pump 24 (FIG. 1). The supply passages 140 and 142 extend between the spool bore 104 and an external surface of the manifold, such as the second side 36. For example, the supply passages 140 and 142 fluidly connect to the spool bore 104 at locations intermediate the longitudinal ends 112 and 114, such as with respect to locations along the spool axis 110. The supply passages 140 and 142 are separated from one another in the spool bore 104 by the spool 102. In other embodiments the supply passages 140 and 142 may extend to another suitable surface where the pump 24 is disposed elsewhere in the power unit 20. The supply passages 140 and 142 may have any suitable plugs 144 separating the passages 140 and 142 from an external surface of the manifold 30, such as the intermediate surface 130. The plugs 144 may be inserted into the passages 140 and 142 or may be integral with the manifold body 108. In some embodiments, separate plugs 144 may be attached to the manifold body 108 via welding, adhesives, etc.

The manifold body 108 further defines a return passage 150 for fluid communication between the spool valve assembly 100 and the reservoir 26. The return passage 150 extends between the spool bore 104 and an external surface of the manifold 30, such as the second side 36. Along the spool axis 110, the spool bore 104 opens to the return passage 150 at a location located, such as centrally located, between the two supply passages 140 and 142 and between the two work passages 120 and 122. The return passage 150 may have a plug 152 separating the return passage 150 from an external surface of the manifold 30, such as the intermediate surface 130. The plug 152 may be inserted into the manifold body 108 or may be integral with the manifold body 108. A separate plug 152 may be attached to the manifold body 108 via welding, adhesives, etc.

The movable spool 102 translates within the spool bore 104 between default, first and second positions in response to pressure received from the supply passages 140 and 142. Depending on position of the spool 102, the return passage 150 may be fluidly separated in the spool bore 104 from each of the supply passages 140 and 142 and work passages 120 and 122, or the return passage 150 may be fluidly connected in the spool bore to only one of the work passages 120 and 122 at a time.

Regardless of the spool's position, the return passage 150 is not fluidly connectable to the supply passages 140 and 142 via the spool bore 104. Further, the work passages 120 and 122 are not fluidly connectable to one another within the spool bore 104 via the spool 102. Likewise, the supply passages 140 and 142 are not fluidly connectable to one another within the spool bore 104 via the spool 102.

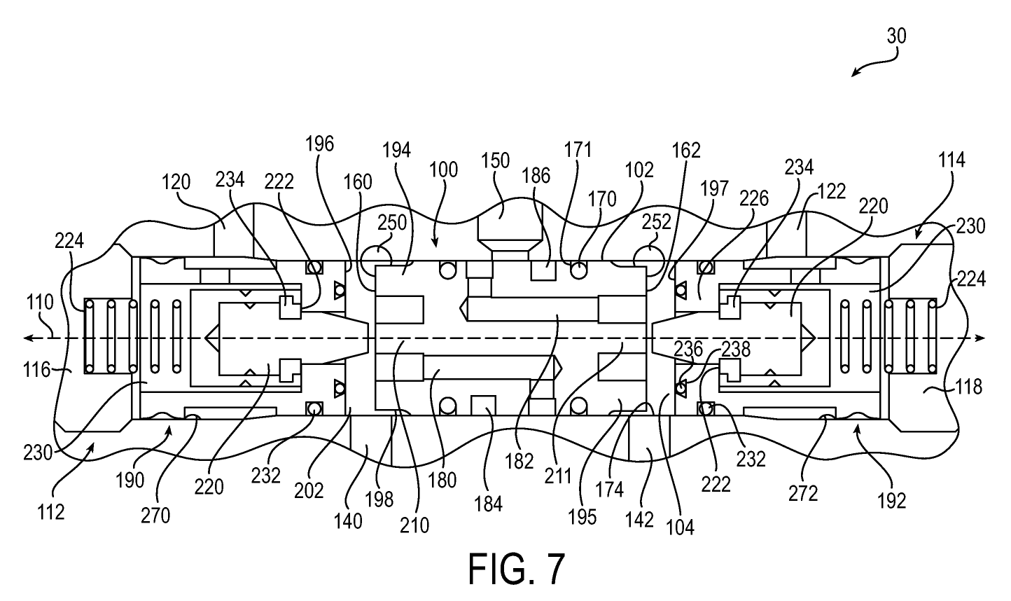

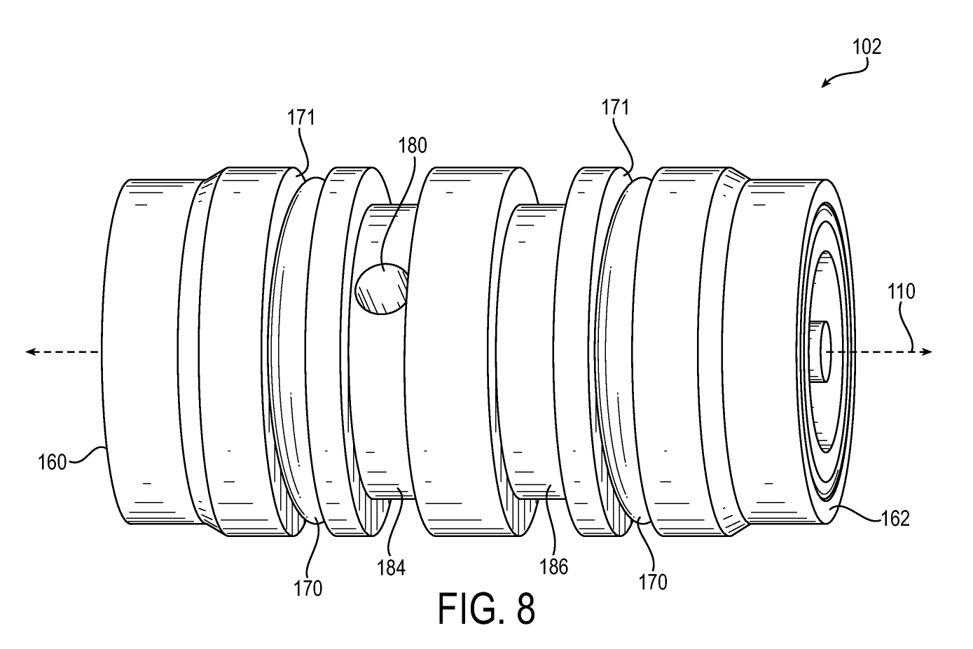

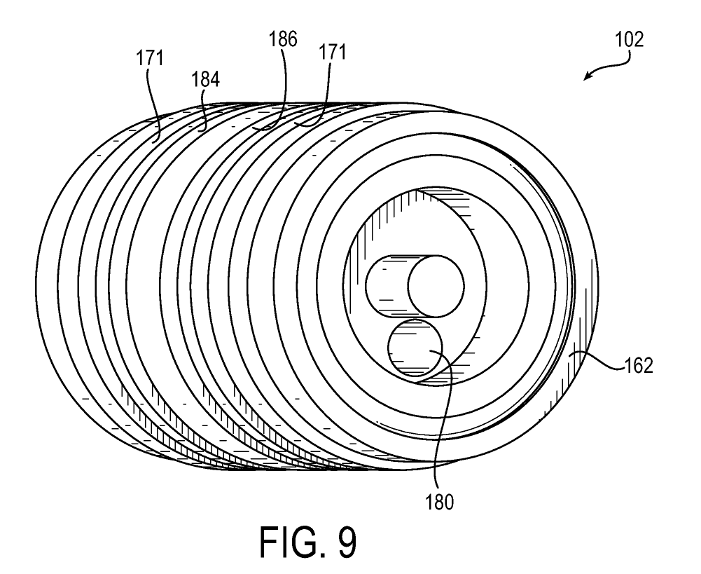

Turning to FIGS. 7-9, the spool 102 is configured, such as being shaped, to control the fluid flow through the spool valve assembly 100 at each of the default, first and second positions. For example, the depicted spool 102 extends between opposed longitudinal spool end surfaces 160 and 162, which are fluidly separated from one another in the spool bore 104.

The depicted end surfaces 160 and 162 are separated, such via seals 170, such as o-rings, extending circumferentially about the spool axis 110. A pair of seals 170 may be engaged between the spool 102 and the spool bore 104, though any suitable number of seals may be used. The seals 170 are shown as seated in grooves 171 extending radially inwardly into an intermediate spool surface extending between the end surfaces 160 and 162. In other embodiments, the seals 170, additional seals, or other seals may instead be seated in grooves in the inner surface 174 of the spool bore 104.

The spool 102 further includes a pair of transfer passages 180 and 182 extending therethrough. Each transfer passage 180 and 182 is fluidly separated from one another in the spool 102. The transfer passages 180 and 182 are also fluidly separated from one another in the spool bore 104, such as via the seals 170. Each transfer passage 180 and 182 extends through the spool 102 to enable fluid connection between the return passage 150 and no more than one of the work passages 120 or 122 at a time, upon alignment of the respective transfer passage 180 or 182 with the return passage 150 when the spool 102 is appropriately translated. Alternatively, depending on the position of the spool 102 along the spool axis 110, neither transfer passage 180 and 182 may be fluidly connected with the return passage 150 in the spool bore 104.

As shown, the first transfer passage 180 extends from the first end surface 160 to a spool surface intermediate the end surfaces 160 and 162, while the second transfer passage 182 extends from the second end surface 162 to another spool surface intermediate the end surfaces 160 and 162. For example, the spool surfaces intermediate the end surfaces 160 and 162 may be a groove 184 or 186 extending radially inwardly into the intermediate spool surface 172 and fluidly connectable with the return passage 150 upon translation of the spool 102. The grooves 184 and 186 provide for fluid connection of the transfer passages 180 and 182 with the return passage 150 via overlapping of the grooves 184 and 186 with the return passage 150, as compared to direct alignment of each of the transfer passages 180 and 182 with the return passage 150. Thus the spool 102 may rotate about the spool axis 110 without the need to prohibit rotation of the spool 102 relative to the spool bore 104.

It will be appreciated that in some embodiments, more than one transfer passage may extend from either of the end surfaces 160 and 162 to the spool surface intermediate the end surfaces 160 and 162. The more than one transfer passages extending from one of the end surfaces 160 and 162 may fluidly connect at the spool surface intermediate the end surfaces 160 and 162 or elsewhere along their path through the spool 102, such as at the respective of the grooves 184 or 186.

Each spool end surface 160 and 162 is configured, such as being shaped, to engage and open a respective check valve 190 or 192 disposed at a respective longitudinal end 112 or 114 of the spool bore 104. Referring to the first spool end surface 160, but equally relevant to the second spool end surface 162, projection portions extend, from the end surface 160 for engaging the first check valve 190. A radially outward portion, such as a skirt 194, is engageable with a check seat face 196 of the check valve 190. The skirt 194 extends from the end surface 160, such as longitudinally extending about the spool axis 110. The depicted skirt 194 is a full annular projection extending fully circumferentially about the spool axis 110. A skirt 195 likewise extends in the same manner as the skirt 194, but from the second end surface 162, for engaging with a respective check seat face 197 of the second check valve 192.

The transfer passage 180 opens to the end surface 160 radially inward of the skirt 194. Thus via sealing engagement of the skirt 194 with the check seat face 196, the first transfer passage 180 is fluidly separated in the spool bore 104 from the first supply passage 140. A radially outward surface 198 of the skirt 194 is spaced, such as radially inwardly, from the inner surface 174 of the spool bore 104. Thus when the skirt 194 is sealingly engaged with the check seat face 196, pressure and fluid may enter the spool bore from the supply passage 140 into an initiation space 202 of the spool bore 104, defined between the radially outward surface 198, check valve 190 and inner surface 174 of the spool bore 104, thus enabling translation of the spool 102.

The check valves 190 and 192 are also opened via pressure from the supply passages 140 and 142 or via engagement with another respective projection portion extending from each end surface 160 and 162, depending on positioning of the spool 102. Referring to the first spool end surface 160, but equally relevant to the second spool end surface 162, a tang 210 extends from the end surface 160, such as longitudinally along the spool axis 110. Thus the depicted tang 210 is centrally disposed with respect to the spool end surface 160 and is positioned radially inwardly of the skirt 194 and of the opening of the first transfer passage 180 to the end surface 160.

As shown, the tang 210 extends the same length from the first end surface 160 as the skirt 194. Though in other embodiments, the tang 210 and the skirt 194 may extend different lengths from the end surface 160. The depicted tang 210 is cylindrically-shaped, though it may be of another suitable shape in other constructions. Further, a tang 211 likewise extends in the same manner as the tang 210, but from the second end surface 162 for engagement with the second check valve 192.

The check valves 190 and 192, which are disposed adjacent the respective of the end surfaces 160 and 162, are fluidly separated from one another in the spool bore 104 via the spool 102, such as via the seals 170. The check valves 190 and 192 are disposed in the spool bore 104, each between the spool 102 and a respective one of the plugs 116 and 118.

Each check valve 190 and 192 is fluidly positioned in the spool bore 104 between one work passage of the pair of work passages 120 and 122 and the remainder of the work, supply, return, and transfer passages. Via combination of the check valves 190 and 192 and the spool 102 translatable in the spool bore 104, the manifold 30 is configured to prevent fluid flow through the spool bore 104 in a direction from either of the work passages 120 or 122 to each of the supply passages 140 and 142. Thus fluid entering the spool bore 104 from the work passages 120 and 122 is directed to the return passage 150 and is fluidly separated from the supply passages 140 and 142.

Turning back to the check valves 190 and 192, each check valve has a respective movable member, such as a poppet 220. Each poppet 220 is movable, such as along the spool axis 110, to engage a respective poppet seat 222. Each poppet 220 extends through a respective check valve wall 226, where each wall 226 is at least partially defined by the respective check seat faces 196 or 197 and the respective poppet seat 222. The poppets extend through the walls 226 to enable engagement with the spool 102. A respective biasing member, such as a spring 224, biases each poppet 220 towards the respective poppet seat 222. The poppets 220 are moved from the poppet seats 222 upon presentation with a force great enough to overcome the springs 224, such as upon physical engagement with the tangs 210 and 211 or in response to pressure from the respective supply passages 140 and 142.

Internal cavities 230 of each check valve 190 and 192 are in continuous communication with the respective work passages 120 and 122, but are sealed in the spool bore 104 from the remainder of the supply, transfer, and return passages, such as via a plurality of seals. With respect to each of the check valves 190 and 192, a seal 232 such as an o-ring is disposed between the inner surface 174 of the spool bore 104 and a portion of the check valve, such as the check valve wall 226. A seal 234, such as an o-ring, may also be disposed between the poppet 220 and the poppet seat 222, such as carried by the poppet 220 and/or disposed about the spool axis 110. In some embodiments, one or more of the seals 234 may be omitted.

Another seal 236, such as an o-ring, may be disposed between the respective check seat faces 196 or 197 and the respective skirt 194 or 195. For example, the seal 236 may be carried by either of the respective skirt 194 or 195 or the respective check valve wall 226, and/or the seal 236 may be disposed about the spool axis 110. In the depicted embodiment each seal 236 is disposed in a dovetail shaped groove 238 extending inwardly into the respective check seat faces 196 or 197 of the respective check valve 190 or 192. In some embodiments, the seal 236 may be molded into a check seat face. In some embodiments, one or more of the seals 236 may be omitted.

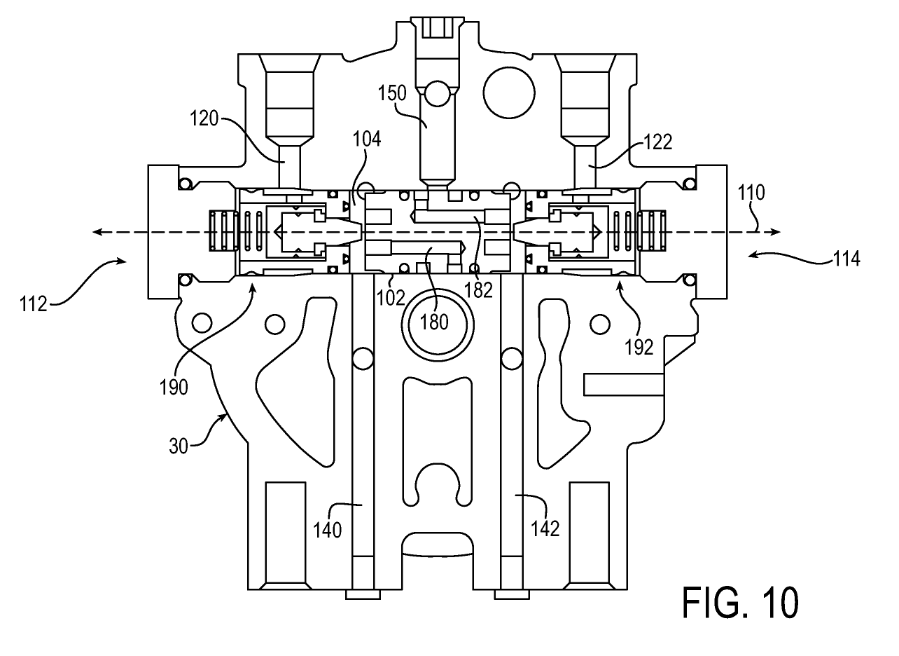

As mentioned, the spool 102 translates between default, first and second positions to control the fluid flow through the spool valve assembly 100 and thus through the manifold 30. Referring now to FIG. 10, the default position of the spool 102 is disposed in the spool bore 104 along the spool axis 110 intermediately between, such as centrally disposed between, the longitudinal ends 112 and 114 of the spool bore 104. When in the default position, the work passages 120 and 122, the supply passages 140 and 142, the return passage 150, and the transfer passages 180 and 182 are each fluidly separated from one another in the spool bore 104.

For example, upon initial startup of the power unit 20, the spool 104 may be in the default position, where no fluid is being driven or drawn through the spool valve assembly 100 between the work unit and either of the pump 24 and reservoir 26. The check valves 190 and 192 will remain closed. Further, each of the transfer passages 180 and 182 is fluidly separated from the return passage 150 in the spool bore 104.

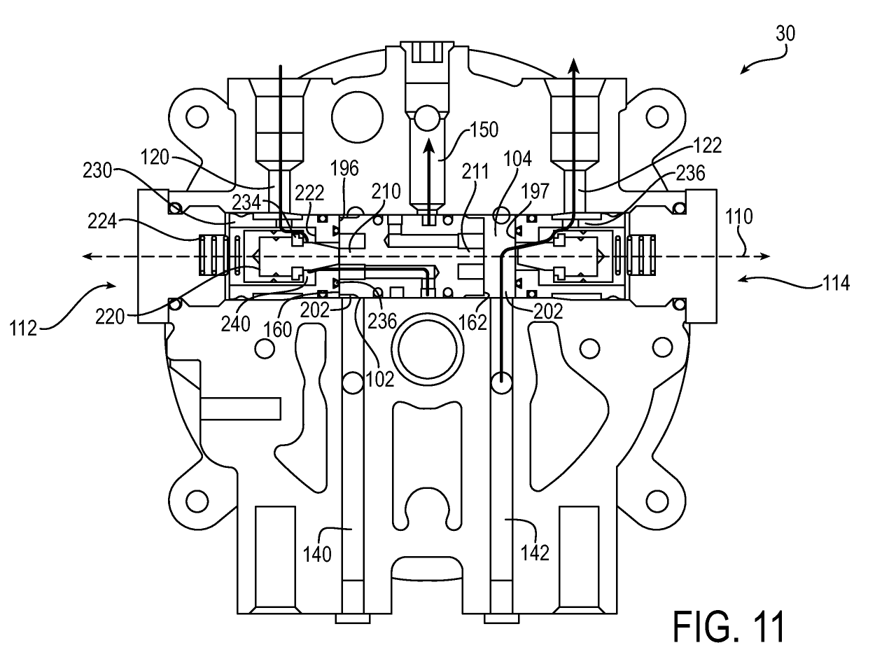

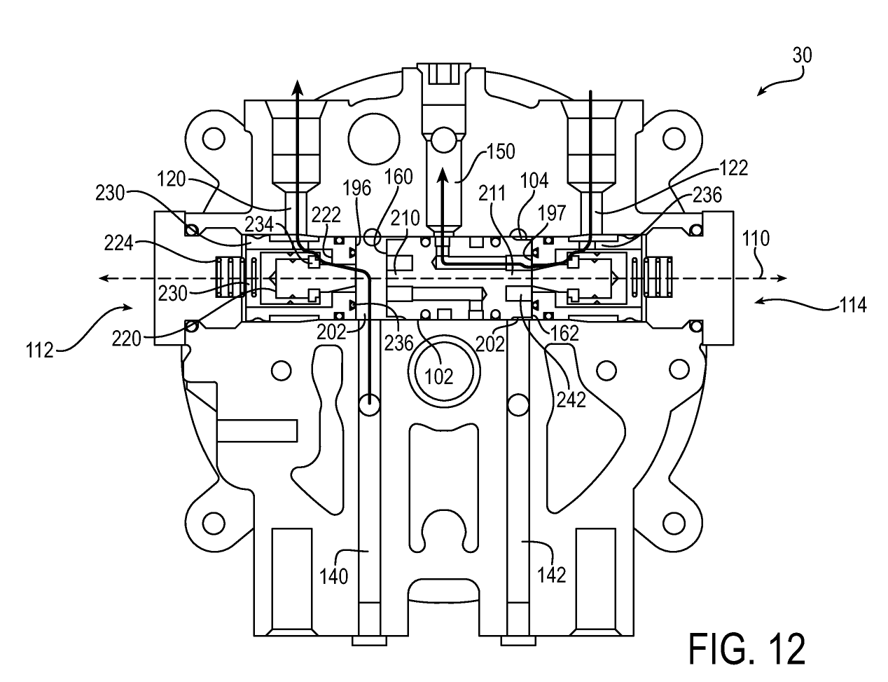

Turning next to FIGS. 11 and 12, the spool 102 also translates along the spool axis 110 between the first position and the second position, each spaced from the default position, to control fluid connection through the spool bore 104 alternatively between each of the supply passages 140 and 142 and the respective work passages 120 and 122. The first position of the spool 102 is disposed adjacent the first longitudinal end 112 and is shown in FIG. 11. Pressure from the second supply passage 142 causes the spool 102 to translate towards the first longitudinal end 112 towards the first position. The second position of the spool 102 is disposed adjacent the second longitudinal end 114 and is shown in FIG. 12. Pressure from the first supply passage 140 causes the spool 102 to translate towards the second longitudinal end 114 towards the second position.

Generally, in either of the first or second positions, the return passage 150 and one work passage 120 or 122 of the pair of work passages 120 and 122 is fluidly connected to one another in the spool bore 104, while the return passage 150 is fluidly separated from the other work passage 120 or 122 of the pair of work passages 120 and 122 in the spool bore 104. When the spool 102 is in each of the first and second positions, the one work passage 120 or 122 of the pair of work passages 120 and 122 is fluidly separated from both of the supply passages 140 and 142 in the spool bore 104. Concurrently, the other work passage 120 or 122 and only one supply passage 140 or 142 are fluidly connected to one another in the spool bore 104, while the other supply passage 140 or 142 is fluidly separated from each of the work passages 120 and 122 and the return passage 150 in the spool bore 104 at each of the first and second positions of the spool 102.

Additionally, in each of the first and second positions, one of the transfer passages 180 and 182 provides for fluid connection of one of the work passages 120 and 122 with the return passage 150. While the respective transfer passage 180 or 182 is aligned with the return passage 150, the respective skirt 194 or 195 is engaged with the respective check valve 190 or 192 to fluidly separate the return passage 150 and the work passage 120 or 122 to which it is currently fluidly connected from the supply passages 140 and 142. Also while the respective transfer passage 180 or 182 is aligned with the return passage 150, the respective tang 210 or 211 engages the respective poppet 220 to open the respective check valve 190 or 192 thus fluidly connecting the return passage 150 and the respective transfer passage 180 or 182 with the respective work passage 120 or 122.

Turning particularly to FIG. 11 showing the first position of the spool 102, (a) fluid is allowed to flow from the first work passage 120 into the return passage 150 through the spool bore 104, (b) fluid is allowed to flow from the second supply passage 142 to the second work passage 122 through the spool bore 104, and (c) the spool 102 fluidly separates the first supply passage 140 from the other of the work, supply and return passages through the spool bore 104.

To provide this particular fluid movement and separation, the prime mover 22 causes fluid flow to leave the fluid pump 24. Flow enters the manifold 30 from the pump 24 via the second supply passage 142 and enters the spool bore 104 adjacent the second longitudinal end 114. The respective poppet 220 of the check valve 192 is initially in a closed position engaging the respective poppet seat 222 due to trapped pressurized fluid behind the poppet 220 in the check valve cavity 230 and/or due to spring force provided by the respective spring 224.

In the closed position of the second poppet 222, fluid and pressure in the spool bore 104 from the second supply passage 142 builds until the poppet 220 is unseated in the second check valve 192, opening up a flow path in the check valve wall 226 into the cavity 230. For example, the respective seal 234 is unseated from the respective poppet seat 222. Flow travels into the second work passage 122 and into one of the opposed work ports of the respective work unit. One side of the hydraulic cylinder work unit begins to receive fluid and pressure.

At the same time that the fluid in the spool bore 104 acts the second check valve 192, the fluid also acts on the spool 102, and particularly on the second side 162 of the spool 102. Fluid entering the spool bore 104 from the second supply passage 142 first enters the respective initiation space 202 adjacent the second longitudinal end 114, thus acting on the second side 162 of the spool 102. The spool 102 is caused to translate in the spool bore 104 along the spool axis 110 towards the first longitudinal side 112 and the first check valve 190 into the first position of the spool 102.

In the first position, the tang 210 extending from the first side 160 of the spool 102 engages the respective poppet 220 of the first check valve 190. The force of the spring 224 is overcome, unseating the poppet 220 from the poppet seat 222, opening a flow path in the check valve wall 226 of the first check valve 190. The respective spring 224 is compressed, and the travel of the spool 102 and respective poppet 220 is stopped.

Moreover, the first longitudinal side 160 of the spool 102 and the skirt 194 are engaged with the check seat face 196. For example, the skirt 194 is engaged with the respective seal 236. Thus a sealed gallery 240 is formed that is sealed off from the first supply passage 140. An open path is created from the first work passage 120 and the respective check valve cavity 230 to the first transfer passage 180, the groove 186 and the return passage 150. Fluid, gas, and contaminant received into the first work passage 120 from the work unit is directed to the return passage 150 and the reservoir 26 while bypassing the first supply passage 140 and the pump 24.

Thus the opposed side of the hydraulic cylinder work unit is emptied of fluid, dropping the pressure in the opposed side. The fluid is directed into the return passage 150 and to the reservoir 26. Once in the reservoir 26, the fluid will have a chance to cool and be filtered via the filters 42 prior to moving to the pump 24. Further, gas in the reservoir 26 may be vented to atmosphere via a suitable vent of the reservoir 26.

Turning next to FIG. 12, when it is desired to move the hydraulic cylinder work unit in the opposite direction, the rotational direction of the prime mover 22 is reversed, generally moving the spool 102 to the second position adjacent the second longitudinal end 114. Flow through the spool valve assembly 100, and thus through the manifold 30, is generally reversed. In the second position, (a) fluid is allowed to flow from the second work passage 122 into the return passage 150 through the spool bore 104, (b) fluid is allowed to flow from the first supply passage 140 to the first work passage 120 through the spool bore 104, and (c) the spool 102 fluidly separates the second supply passage 142 from the other of the work, supply and return passages through the spool bore 104.

More particularly, the spool 102 is moved into the second position towards the second longitudinal end 114 in response to the pressure and fluid entering the respective initiation space 202 and the remainder of the spool bore 104 adjacent the first longitudinal end 112 via the first supply passage 140. The poppet 220 of the first check valve 190 is moved to the open position also in response to the pressure and fluid entering the respective initiation space 202 and the remainder of the spool bore 104 adjacent the first longitudinal end 112 via the first supply passage 140.

At the second longitudinal end 114, the second check valve 192 is opened as the poppet 220 of the second check valve 192 is engaged by the tang 211 extending from the second longitudinal side 162 of the spool 102. The second longitudinal side 162 of the spool 102 and the skirt 195 are engaged with the check seat face 197. For example, the skirt 195 is engaged with the respective seal 236. Thus a sealed gallery 242 is formed that is sealed off from the second supply passage 140. An open path is created from the second work passage 122 and the respective check valve cavity 230 to the second transfer passage 182, the groove 184 and the return passage 150. Fluid, gas, and contaminant received into the second work passage 122 from the work unit is directed to the return passage 150 and the reservoir 26 while bypassing the second supply passage 142 and the pump 24.

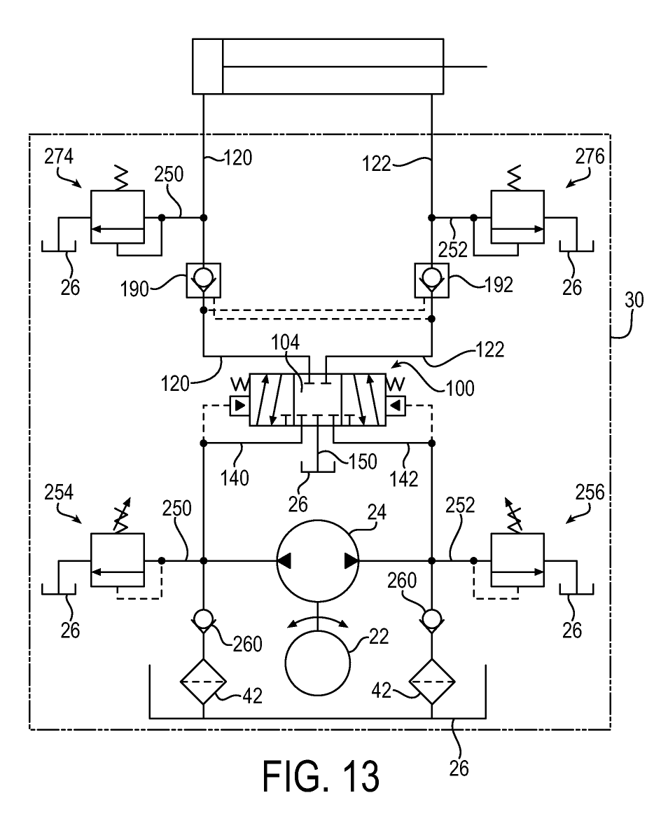

Referring now to FIG. 13, but also referring to FIG. 6, the manifold 30 may include additional relief valves 254, 256, 274 and/or 276 that may cooperate with the spool valve assembly 100 to increase efficient movement of fluid through the manifold 30.

Relief valves 254 and 256 may be provided to limit the maximum pressure or hydraulic power directed to the work unit from the manifold 30. Relief passage 250 (FIGS. 6 and 13) may lead to a respective relief valve 254 (FIG. 13), that is fluidly connected to the reservoir 26, to limit pressure in the spool bore 104 when flow is entering the manifold 30 via the respective supply passage 140. Relief passage 252 (FIGS. 6 and 13) may lead to respective relief valve 256 (FIG. 13), that is also fluidly connected to the reservoir 26, to limit pressure in the spool bore 104 when flow is entering the manifold 30 via the respective supply passage 142.

Additional relief valves, such as thermal relief valves 274 and 276 may be provided. In such case, if the power unit 20 is exposed to heat, such as via the sun, for example, causing pressure in the power unit 20 and associated hoses (and or work device) to increase, an amount of fluid may escape to the reservoir 26. Relief passage 270 (FIG. 6) may lead to a respective relief valve 274 (FIG. 13), that is fluidly connected to the reservoir 26, to limit pressure in the check valve cavity 230 (FIG. 7) of the first check valve 190. Relief passage 272 (FIG. 6) may lead to respective relief valve 276 (FIG. 13), that is also fluidly connected to the reservoir 26, to limit pressure in the check valve cavity 230 of the second check valve 192. In some embodiments, each of the relief valves 274 and 276 may configured to open at a pressure above that of the relief valves 254 and 256.

Consistent with the foregoing, the present invention includes a method of controlling flow between the work passages 120 and 122 of the manifold 30 including the spool valve assembly 100 having the spool 102 translatable within the spool bore 104, where the spool bore 104 is fluidly connected to (a) the first and second work passages 120 and 122 for connecting to a respective work unit, (b) the respective first and second supply passages 140 and 142 for connecting to the hydraulic pump 24, and (c) the return passage 150 for connecting to the fluid reservoir 26. The method includes the steps of (i) in a default position of the spool 102, fluidly separating each of the work passages 120 and 122, supply passages 140 and 142 and return passage 150 from one another; (ii) in a first position of the spool 102 spaced from the default position, allowing fluid flow from the first work passage 120 to the return passage 150 through the spool bore 104, allowing fluid flow from the second supply passage 142 to the second work passage 122 through the spool bore 104, and fluidly separating the first supply passage 140 from the other of the work, supply and return passages through the spool bore (120, 122, 142 and 150); and (iii) in a second position of the spool 102 spaced from each of the default and first positions, allowing fluid flow from the second work passage 122 to the return passage 150, allowing fluid flow from the first supply passage 140 to the first work passage 120, and fluidly separating the second supply passage 142 from the other of the work, supply and return passages (120, 122, 140 and 150).

The method also includes the step of translating the spool 102 between the first and second positions in response to pressure received from the supply passages 140 and 142. The method further includes the step of directing fluid flow received into either work passage 120 or 122 of the manifold 30 to the reservoir 26 while bypassing the hydraulic pump 24.

Accordingly, the invention provides a hydraulic power unit 20 for controlling a work unit. The power unit 20 includes a reservoir 26 for storing hydraulic fluid, a hydraulic pump 24 for moving fluid from the reservoir 26, a prime mover 22 for driving the hydraulic pump 24, and a manifold 30 for controlling flow between the work unit and the pump 24 and reservoir 26. The manifold 30 includes a spool valve assembly 100 with a spool 102 that is translatable within a spool bore 104 to provide this control. The spool bore 104 is fluidly connected to the work unit via a pair of work passages 120 and 122, to the hydraulic pump 24 via a pair of supply passages 140 and 142, and to the reservoir 26 via a return passage 150. The manifold 30 is configured to direct fluid flow received from the work unit at either of the work passages 120 and 122 to the reservoir 26 while bypassing the pump 24 by preventing fluid flow through the spool bore 104 in a direction from either of the work passages 120 or 122 to either of the supply passages 140 or 142.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A manifold for controlling flow between work passages of the manifold to provide hydraulic work force to a work unit connectable to the manifold, the manifold comprising:
a manifold body defining a spool bore extending along a longitudinal spool axis between opposed longitudinal ends;
a pair of work passages for fluid communication with the work unit, a pair of supply passages for fluid communication with a supply of fluid, and a return passage for fluid communication with a fluid reservoir, wherein each of the work passages, supply passages and return passage extend between an external surface of the manifold body and the spool bore; and
a movable spool disposed in the spool bore that fluidly separates the work passages from one another and the supply passages from one another in the spool bore, the spool longitudinally translatable along the spool axis between first and second positions at the opposed longitudinal ends and a default position spaced between the first and second positions to control flow of fluid between the work, supply and return passages,
wherein the work passages and the supply passages are each fluidly separated from the return passage in the spool bore when the spool is in the default position, and wherein the return passage and one work passage of the pair of work passages are fluidly connected to one another in the spool bore while the return passage is fluidly separated from the other work passage of the pair of work passages in the spool bore when the spool is in each of the first and second positions.

2. The manifold of claim 1, wherein the spool translates in response to pressure received from the supply passages.

3. The manifold of claim 1, wherein the spool has opposed longitudinal spool end surfaces fluidly separated from one another in the spool bore via a seal disposed at least partially in the spool bore between the longitudinal spool end surfaces.

4. The manifold of claim 1, wherein the one work passage of the pair of work passages is fluidly separated from the supply passages in the spool bore when the spool is in each of the first and second positions.

5. The manifold of claim 1, wherein the other work passage of the pair of work passages and one supply passage of the pair of supply passages are fluidly connected to one another in the spool bore, while the other supply passage of the pair of supply passages is fluidly separated from each of the work passages, the one supply passage and the return passage in the spool bore when the spool is in each of the first and second positions.

6. The manifold of claim 1, wherein each work passage of the pair of work passages opens to one of the opposed longitudinal ends of the spool bore.

7. The manifold of claim 1, wherein the spool further includes a pair of transfer passages defined therein and fluidly separated from one another, wherein each transfer passage extends between one longitudinal spool end surface and a longitudinal spool surface extending between the longitudinal spool end surfaces, and wherein each transfer passage provides for fluid connection of the one or the other of the work passages with the return passage upon alignment of the respective transfer passage with the return passage when the spool is in each of the first and second positions.

8. The manifold of claim 7, wherein each of the transfer passages is fluidly separated from the return passage in the spool bore when the spool is in the default position.

9. The manifold of claim 1, wherein the spool further includes a skirt extending longitudinally from each of opposed longitudinal spool end surfaces of the spool, wherein the skirt fluidly separates the one work passage of the pair of work passages from the respective supply passage in the spool bore when the spool is in each of the first and second positions.

10. The manifold of claim 9, wherein each skirt is a full annular projection.

11. The manifold of claim 1, further including a pair of check valves disposed at the opposed longitudinal ends of the spool bore, wherein each check valve is fluidly positioned between one work passage of the pair of work passages and the remainder of the work, supply and return passages.

12. The manifold of claim 11, wherein each check valve includes a check seat for mating with the spool to fluidly separate the one work passage of the pair of work passages from the respective supply passage in the spool bore when the spool is in each of the first and second positions.

13. The manifold of claim 11, wherein the spool further includes a tang extending longitudinally from each of the opposed longitudinal spool end surfaces to engage and open one of the check valves when the spool is in each of the first and second positions.

14. The manifold of claim 1, wherein the manifold is configured to prevent fluid flow through the spool bore in a direction from either of the work passages to either of the supply passages.

15. A hydraulic power unit for controlling flow between opposed work ports of a work unit, the hydraulic power unit comprising:
a reservoir for hydraulic fluid;
a hydraulic pump for moving fluid from the reservoir;
a prime mover for causing the hydraulic pump to move the fluid; and
the manifold of claim 1, wherein the pair of work passages are connected to the work unit, the return passage is connected to the reservoir, and the pair of supply passages are connected to the hydraulic pump to receive fluid pumped from the hydraulic pump.

16. A hydraulic power unit for controlling flow between opposed work ports of a work unit, the hydraulic power unit comprising:
a reservoir for hydraulic fluid;
a hydraulic pump for moving fluid from the reservoir;
a prime mover for causing the hydraulic pump to move the fluid; and
a manifold fluidly connected to each of the reservoir and the hydraulic pump, the manifold including a spool valve assembly for controlling fluid flow between the work unit and each of the pump and the reservoir, wherein the spool valve assembly is configured to direct fluid flow received from either of the work ports to the reservoir while bypassing the hydraulic pump.

17. The hydraulic power unit of claim 16, wherein the spool valve assembly includes a spool translatable within a spool bore, the spool having opposed longitudinal ends each shaped to prevent fluid flow in a direction from the work unit to the hydraulic pump through the spool bore while directing fluid flow in a direction from the work unit to the reservoir through the spool bore.

18. A method of controlling flow between work passages of a manifold including a spool valve assembly having a spool translatable within a spool bore, the spool bore fluidly connected to (a) first and second work passages for connecting to a work unit, (b) respective first and second supply passages for connecting to a hydraulic pump, and (c) a return passage for connecting to a fluid reservoir, the method including the steps of:
(i) in a default position of the spool, fluidly separating each of the work passages, supply passages and return passage from one another;
(ii) in a first position of the spool spaced from the default position, allowing fluid flow from the first work passage to the return passage through the spool bore, allowing fluid flow from the second supply passage to the second work passage through the spool bore, and fluidly separating the first supply passage from the other of the work, supply and return passages through the spool bore; and
(iii) in a second position of the spool spaced from each of the default and first positions, allowing fluid flow from the second work passage to the return passage, allowing fluid flow from the first supply passage to the first work passage, and fluidly separating the second supply passage from the other of the work, supply and return passages.

19. The method of claim 18, further including the step of translating the spool between the first and second positions in response to pressure received from the supply passages.

20. The method of claim 18, further including the step of directing fluid flow received into either work passage of the manifold from the work unit to the reservoir while bypassing the hydraulic pump.
